(19) United States
(12) Patent Application Publication
(10) Pub. No.: US 2004/0227815 A1
(43) Pub. Date: Nov. 18, 2004

(54) Mechanism for installing video capture device

(76) Inventor: Chun-Tien Chen, Taipei (TW)

Correspondence Address: PRO-TECHTOR INTERNATIONAL, 20775 Norada Court, Saratoga, CA, 95070-3018, US

(21) Appl. No.: 10/439,055

(22) Filed: May 14, 2003

(51) Int. Cl. H04N 7/18

(52) U.S. Cl. 348/151; 348/143

(57) ABSTRACT

A mechanism for installing a video capture device comprises a video capture device, a wireless audio-video transmission, a case, and a lens protective cover. The case contains the video capture device. The lens protective cover has hooking pieces for being lodged in a lens hole on the case. The case is installed within a stuffed puppet behind an eye hole; and the lens protective cover is brought to outer side of the eye hole to have its hook pieces pass through the eye hole and get lodged thereon. This achieves a simple and stable attachment of a video capture device to a stuffed puppet.

### FIELD OF THE INVENTION

The present invention relates to a mechanism for installing a video capture device, more particularly to a fast and stable means of installing a video capture device to the surface of a stuffed toy.

### BACKGROUND OF THE INVENTION

Rapid progress in the technology of video capture devices has not only enhanced the quality and function of video capture devices, but also cut down the price substantially. Therefore, video capture devices of various kinds have been widely used in many aspects of daily life. Toy video cameras, surveillance devices for monitoring the elderly and children, home security devices, video phones, and video conference devices are some examples. A new trend of application is integrating the function of a video capture device with a toy, such as a stuffed puppet, so that a toy becomes a surveillance device. A suitable place to install a video capture device is an eye portion of a stuffed puppet. Because the surface of a stuffed puppet is usually made of soft materials such as cloth or leather, stable installation of a video capture device poses a problem to toy manufacturers.

The conventional way of installation is using powerful adhesive materials to stick a case containing a video capture device to an eye hole on inner surface of the skin of a stuffed puppet; an eye-shaped protective cover is then stuck to the eye hole from outside. It is often that the adhesive material being used stains the lens of the video capture device by mistake during the manufacturing process. It is a further disadvantage that the lens of the video capture device can no more be adjusted once it is installed, making a refocusing for better images impossible. Another way to install a video capture device is to screw an eye-shaped protective cover onto a case containing a video capture device so that the skin of a stuffed puppet is clipped therebetween. The disadvantage of this means is that the protective cover is easy to get unscrewed by external forces and then fall off, leaving the lens of the video capture device unprotected.

### SUMMARY OF THE INVENTION

Accordingly, the primary object of the present invention is to provide a reliable mechanism for installing a video capture device in a stuffed toy. The mechanism utilizes the a simple hooking device between a lens protective cover and a case containing a video capture device so as to clip the video capture device on the skin of a stuffed toy. It is a further stabilization design that a number of grappling humps on the face of the case are inserted into the texture of the skin upon the clipping, so as to achieve a better grappling effect.

It is a further object of the present invention to provide a mechanism for easily uninstalling a video capture device from a stuffed toy. The hooking device of the lens protective cover can be done in reverse order to take off the lens protective cover for maintenance.

The various objects and advantages of the present invention will be more readily understood from the following detailed description when read in conjunction with the appended drawing.

### BRIEF DESCRIPTION OF THE DRAWINGS

FIG. 1 is an exploded view of an embodiment according to the present invention.

FIG. 2 is a lateral cross-sectional view of the embodiment shown in FIG. 1.

FIG. 3 is a system block diagram illustrating the function of the associated wireless audio-video transmission module.

FIG. 4 is a lateral cross-sectional view of another embodiment according to the present invention.

FIG. 5 is a diagram showing the location of a stuffed puppet at which the present invention may be installed.

### DETAILED DESCRIPTION OF THE PREFERRED EMBODIMENTS

An embodiment of a mechanism for installing a video capture device according to the present invention, which is installed in an eye portion of a stuffed puppet 1, is described as follows. Referring to FIGS. 1 to 3, the embodiment comprises a video capture device 2, a wireless audio-video transmission module 3, a case 4, and a lens protective cover 5.

The video capture device 2 contains an image processing circuit 22 and a CCD or CMOS video sensor 23; the image processing circuit 22 is installed on a base 21 of the video capture device 2. An adjustable lens set 24 is installed in front of the video sensor 23. For adjusting the focus, a threaded section 25 around the lens frame allows a change in position of the adjustable lens set 24.

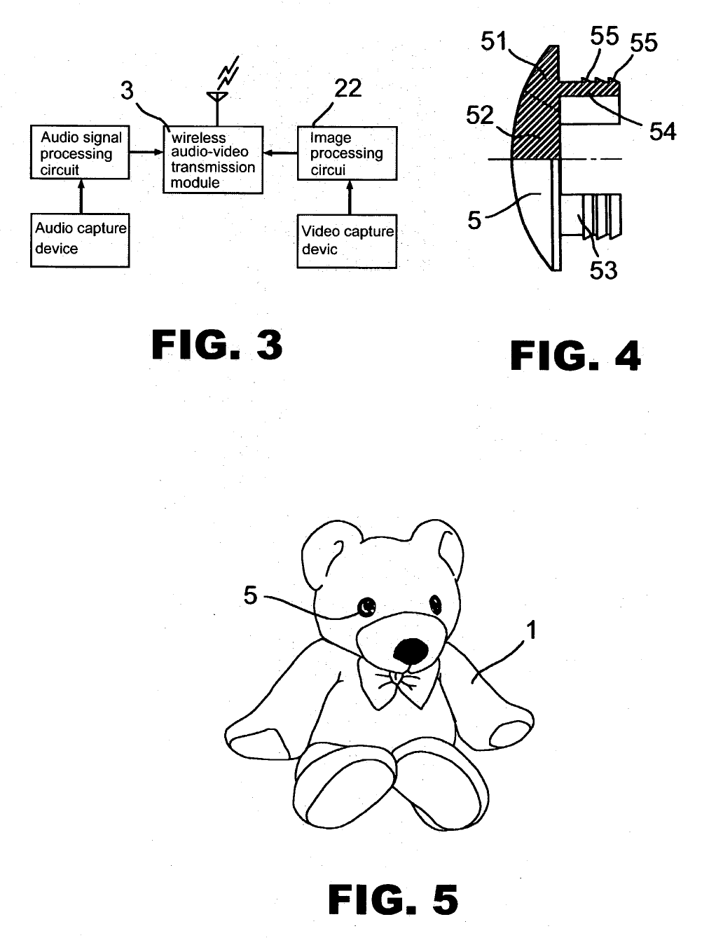

The wireless audio-video transmission module 3 is connected to the image processing circuit 22, capable of transmitting signals from the video capture device 2 to a remote monitor by a wireless mean. An audio capture device can be installed in company with the video capture device 2, if necessary; the audio information captured by the audio capture device is transmitted to the same image processing circuit 22 and then the wireless audio-video transmission module 3 for a wireless transmission. The complete system diagram is shown in FIG. 3.

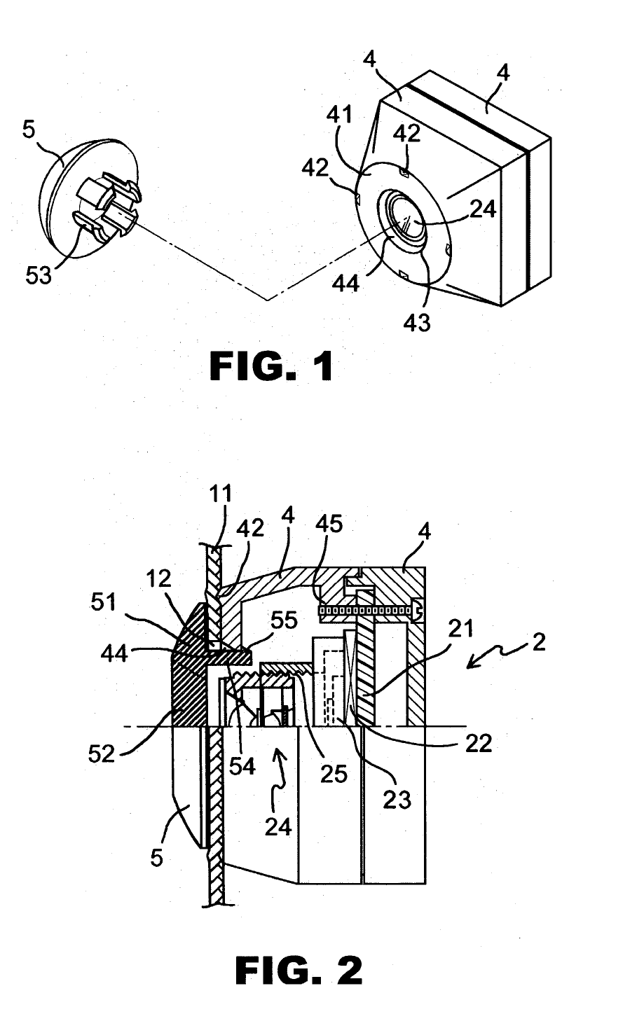

A number of grappling humps 42 are formed on the top face 41 of the case 4. Further, a lens hole 43 is formed at the center of the top face 41. The diameter of the lens hole 43 decreases gradually from outside to inside of the case 4 to form a dipped rim 44. The dipped rim is a better design, though not necessary, in that it facilitates the insertion of the lens protective cover 5. There is a cavity within the case 4 for receiving the video capture device 2. On the opposite of the top face 41, there is an opening. A number of setting screw seats 45 are formed around the inner edge of the opening. The video capture device 2 is inserted into the cavity to have its adjustable lens set 24 extended from the lens hole 43; on the other side, the base 21 of the video capture device 2 is fixed to the setting screw seats 45 by screws. The lens protective cover 5 takes a partial semi-spherical shape and has a transparent portion 52 at the center and a colored ring 51 encircling the transparent portion 52. The lens protective cover 5 simulates the outlook of an eye. The transparent portion 52 can be made of a planar lens (as shown in FIG. 2), a spherical lens (as shown in FIG. 4), or a non-spherical lens manufactured based on holography technology. Further, there are a number of hooking pieces 53 extending from the flat rear surface of the lens protective cover 5. Each of the hooking pieces 53 has a flexible section 54 and a hook-shaped section 55, as shown in FIG. 4. To install the above-mentioned structure to an eye portion of a stuffed puppet 1, the case 4 containing the video capture device 2 is installed at an eye hole 12 on the inner surface of the cover skin 11 of the stuffed puppet 1, whereas the lens protective cover 5 is attached to the eye hole 12 on the outer surface of the cover skin 11. The hooking pieces 53 of the lens protective cover 5 pass through the eye hole 12 and get lodged on the wall around the lens hole 43 to complete the installation. The wireless audio-video transmission module 3 can be adjacent to the case 4 or installed in a suitable position in the stuffed puppet 1 and connected to the case by a wire. After the composition of the case 4 and the lens protective cover 5, the cover skin 11 around the eye hole 12 is clipped tightly therebetween. It is a further stabilizing effect that the grappling humps 42 on the case 4 are imbedded in the texture of the cover skin 11 to achieve a better grappling.

The video capture device according to the present invention has a lens protective cover 5 being the only part exposed outside a stuffed puppet 1. Since the lens protective cover 5 resembles the outlook of an eye, the video capture device 2 is therefore well camouflaged. A stuffed puppet 1 equipped with the video capture device 2 is suitable for some special occasions. For example, the stuffed puppet 1 can be placed as an ornament at a place where children play, for monitoring their activities. Being carried by a child, a stuffed puppet equipped according to the present invention becomes a personal surveillance device that can provide an adult supervisor with a child's whereabouts.

To summarize, by using hooking pieces 53 of the lens protective cover 5 to lodge on the lens hole 43 of the case 4, the installation of a video capture device 2 in a stuffed puppet 1 becomes simple and swift. This mechanism also allows easy dismounting of the video capture device 2 from the stuffed puppet 1 for readjusting focus, changing parts, or any other maintenance. It is a further effect that the grappling humps 42 on the top face 41 of the case 4 make the mounting of the video capture device 2 on the stuffed puppet 1 more stable, largely reducing the possibility of falling off.

An embodiment according to the present invention is thus described. It will be obvious that the same invention may be varied in many ways. For example, as shown in FIG. 4, to accommodate to stuffed puppets with cover skin of different thickness, the hooking pieces 53 of the lens protective cover 5 may have a number of hook-shaped sections 55 so that the strength of clipping can be adjusted according to the thickness of cover skin. Such variations are not to be regarded as a departure from the spirit and scope of the present invention, and all such modifications as would be obvious to one skilled in the art are intended to be included within the scope of the following claims.

What is claimed is:

1. A mechanism for installing a video capture device comprising
a video capture device composed of an image processing circuit, a CCD or CMOS video sensor, and an adjustable lens set; said image processing circuit being installed on a base of said video capture device; said adjustable lens set being installed at a front end of said video capture device,
a wireless audio-video transmission module for transmitting signals from said video capture device to a remote monitor by a wireless mean,
a case having a lens hole and a cavity; said lens hole being formed at a center of a top face of said case; said cavity containing said video capture device; said adjustable lens set of said video capture device extending into said lens hole, and
a lens protective cover being formed by a spherical side and a planar side; said lens protective cover having a transparent portion at a center of said lens protective cover; said lens protective cover having a colored ring encircling said transparent portion; said lens protective cover having a number of hooking pieces extending from said planar side thereof; said hooking pieces having a flexible section and a hook-shaped section;
said case containing said video capture device being installed in a stuffed puppet behind an eye hole under a cover skin of said stuffed puppet; said lens protective cover being attached to an outer surface of said cover skin of said stuffed puppet at said eye hole; said hooking pieces of said lens protective cover passing through said eye hole and getting lodged on a wall around said lens hole so that the composition of said video capture device and said stuffed puppet is completed.

2. The mechanism for installing a video capture device of claim 1, wherein a number of grappling humps are formed on said top face of said case.

3. The mechanism for installing a video capture device of claim 1, wherein the diameter of the circumference that defines the boundary of said lens hole decreases gradually from outside to inside of said case to form a dipped rim.

4. The mechanism for installing a video capture device of claim 1, wherein said hooking pieces of said lens protective cover have a number of hook-shaped sections.

5. The mechanism for installing a video capture device of claim 1, wherein said transparent portion is an optical lens; said optical lens is a planar lens, a spherical lens, or a non-spherical lens manufactured based on the holography technology.
